(19) United States
(12) Patent Application Publication
(10) Pub. No.: US 2013/0201698 A1
(43) Pub. Date: Aug. 8, 2013

(54) PROLight Shield

(71) Applicant: Stephen Joseph Clayton, Murrieta, CA (US)

(72) Inventor: Stephen Joseph Clayton, Murrieta, CA (US)

(73) Assignee: Mr. Stephen Joseph Clayton, Murrieta, CA (US)

(21) Appl. No.: 13/707,026

(22) Filed: Dec. 6, 2012

Related U.S. Application Data
(60) Provisional application No. 61/595,238, filed on Feb. 6, 2012.

(51) Int. Cl. F21V 11/18

(52) U.S. Cl. CPC F21V 11/18
USPC 362/376

(57) ABSTRACT

The invention provides a decorative shielding option for the professional entertainment lighting industry. The stand-alone design enables the lighting technician a quick cosmetic solution for ground up lighting. Constructed from machined aluminum and scored 2 to 4 times, the lightweight design compliments a myriad of up lighting applications. In addition to the valuable decor properties, the shielding maintains a safe boundary between potentially hot up lighting and the event participant.

This non-provisional utility patent application references an earlier provisional utility patent application. The earlier provisional utility patent application No. is 61/595,238 and the filing date was Feb. 6, 2012.

### BACKGROUND OF THE INVENTION

The present invention relates to decorative shielding for professional entertainment up lighting. Although most professional up lighting is made combined with some form of shielding, the PROLight Shield is a stand-alone shield. Lights that are a combination often expose the outer structure of the light's metal body. Besides the undesired look of these lights placed on the floor, most are hot to the touch, with the exception of LED lights, and pose a safety hazard.

### SUMMARY OF THE INVENTION

The PROLight Shield provides a decorative alternative to placing unsecured professional lighting on the floor. Lighting is still positioned on the floor, but with a decorative cover. Made of machined aluminum, the PROLight Shield is heat resistant, which provides a safety barrier between the light and human interaction. The contoured shape of the PROLight Shield enables a sturdy upright profile. The 16-gauge aluminum thickness provides for durability and total stack-ability. The PROLight Shield can be artistically configured to fit different event decor, such as weddings, sports functions and corporate conventions.

The principal objects of the present invention are to provide a decorative cover for professional up lighting while shielding event patrons from hot metal parts and wires. The PROLight Shield has a fairly basic design and cost-effective fabrication process. The PROLight Shield's machined aluminum ensures life long use.

### BRIEF DESCRIPTION OF THE DRAWINGS

FIG. 1 is a front view and measurements of the PROLight Shield;

FIG. 2 is a side view showing the machine scored sides and winged edges;

FIG. 3 is the PROLight Shield Slant Series, a variation of the PROLight Shield;

FIG. 4 is the PROLight Shield Hinged! Series, a variation of the PROLight Shield;

FIG. 5 is a front view actual photo of the PROLight Shield; and

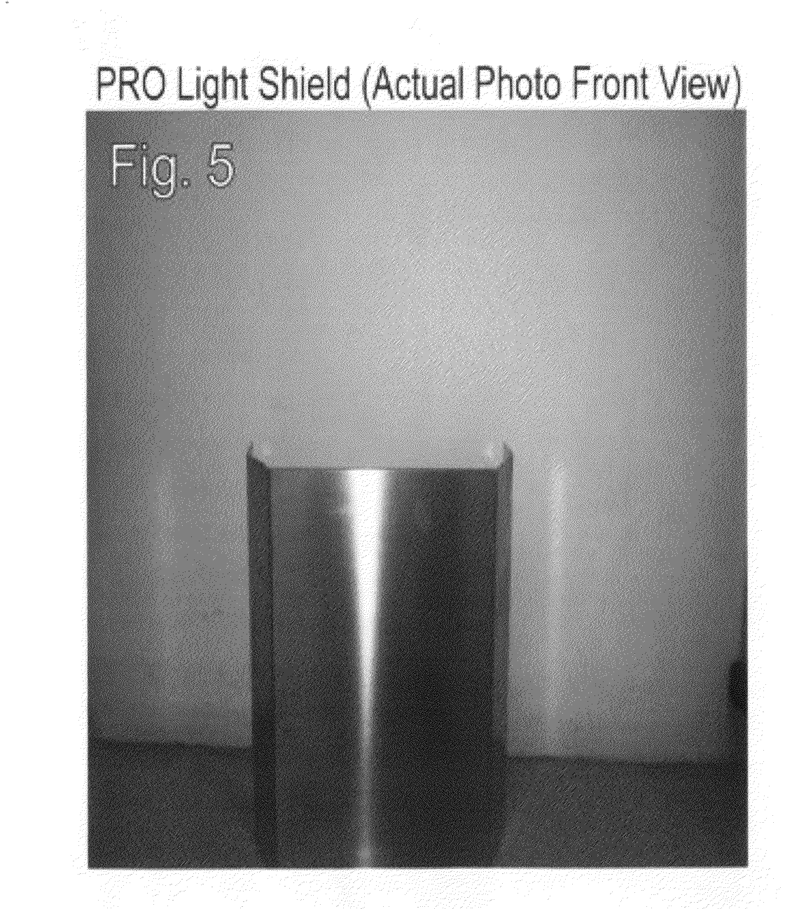

FIG. 6 is a top view actual photo of the PROLight Shield.

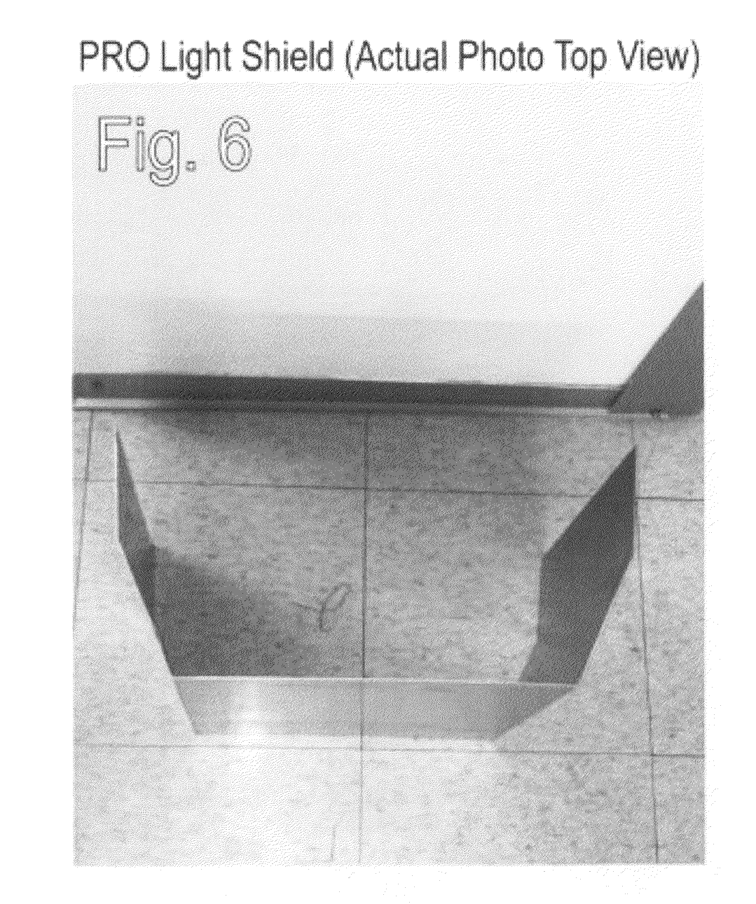

### DETAILED DESCRIPTION OF THE INVENTION

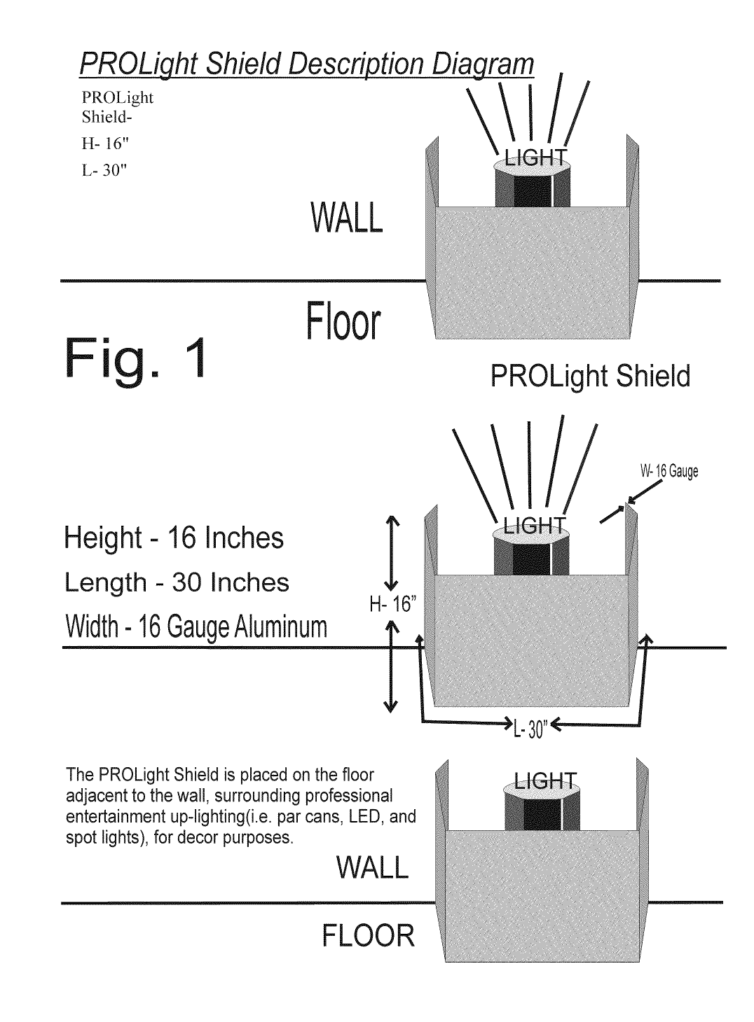

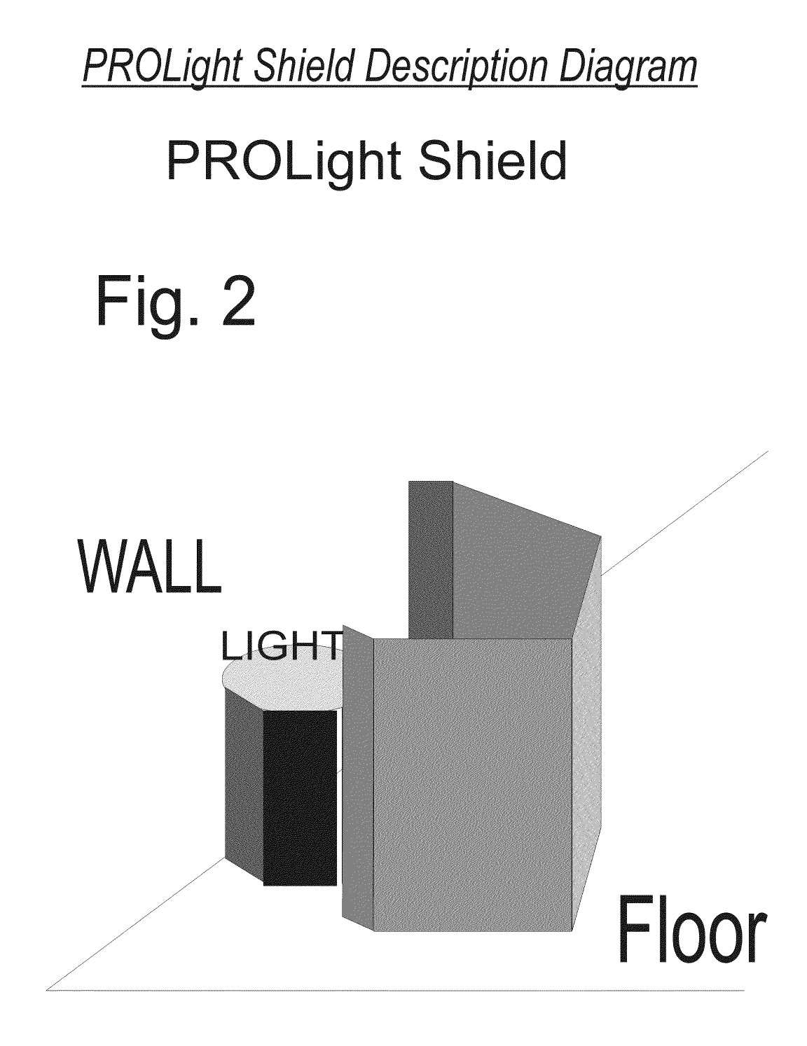

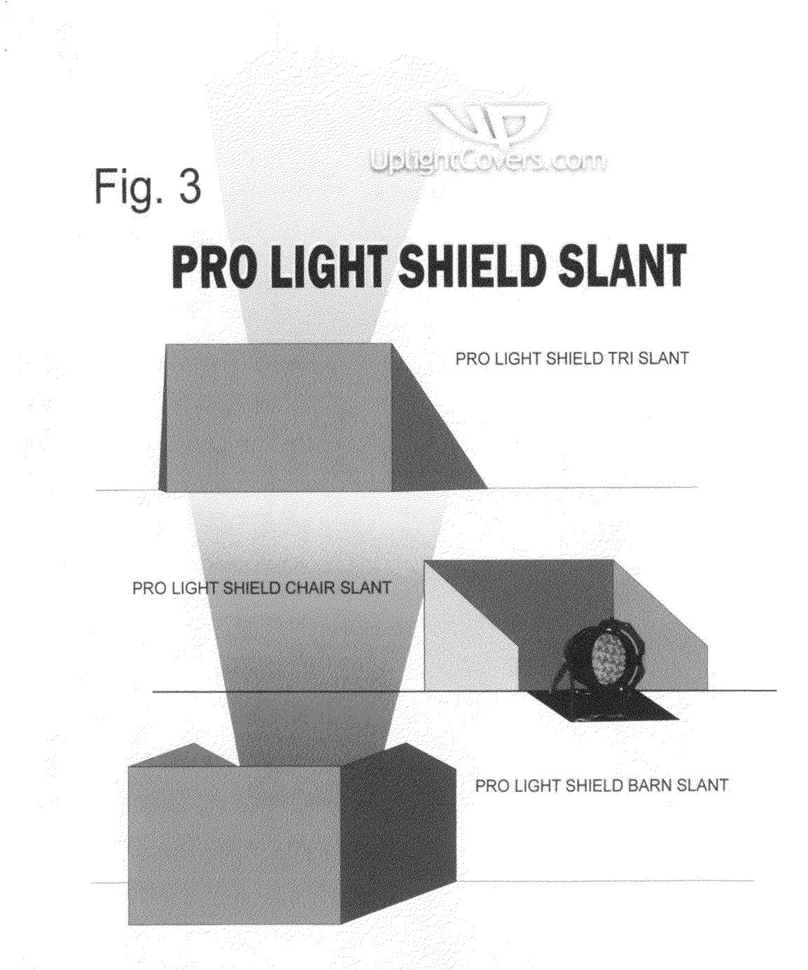

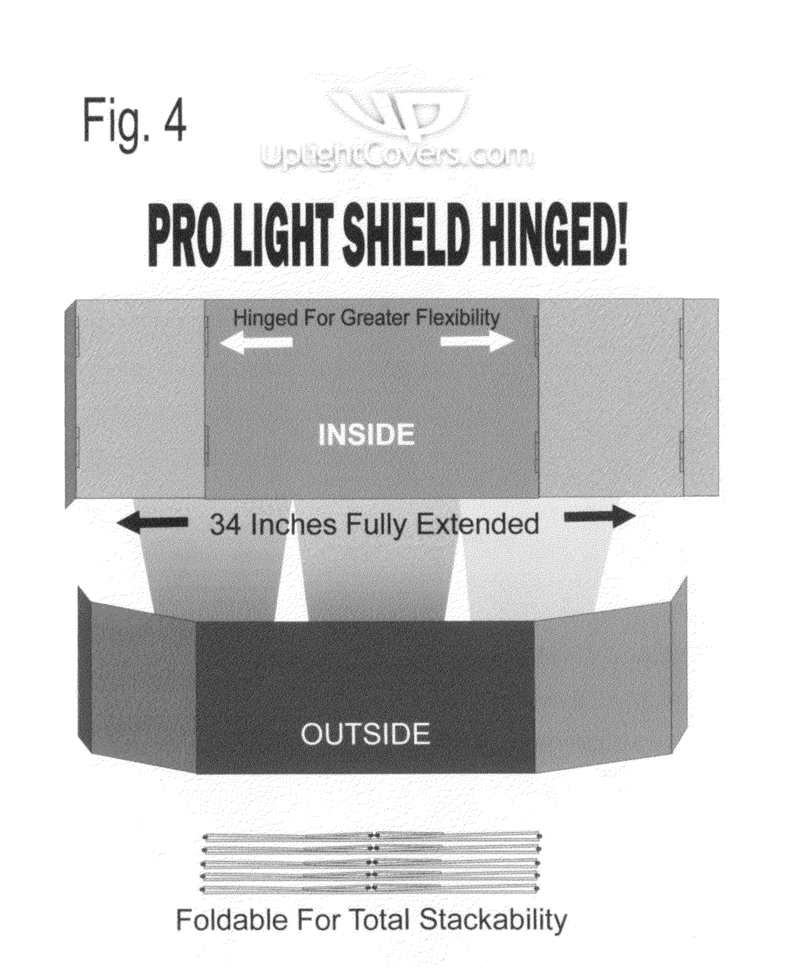

The PROLight Shield is constructed of pressed aluminum. The PROLight Shield primarily has a rectangle shape, although there are variations as shown in FIG. 3. The PROLight Shield is scored four times, although there are variations, which are scored two times. The PROLight Shields measurements, as shown in FIG. 1, are consistent with industry size up lighting. The contoured shape of the PROLight Shield, as shown in FIG. 2, enables a freestanding profile. Variations of the original PROLight Shield, as shown in FIG. 3 and FIG. 4, offer different styles and perspective. Heat resistant with reflective properties allows the PROLight Shield close proximity to the light. The PROLight Shield is manufactured using a metal press machine, which cuts, shapes and scores a divided piece of aluminum.

Modifications may be made to the PROLight Shield without departing from the concepts disclosed within the description. Such modifications are to be considered as included in the following claims unless these claims by their language expressly state otherwise.

The embodiments of the invention in which an exclusive property or privilege is claimed are defined as follows:

1. In a decorative shield for professional uplighting within the entertainment industry and the like.

2. A decorative shield as set forth in claim 1, wherein:
the shield, made of machined aluminum, is placed on the floor or another surface (i.e. table) in front of event uplighting.

3. A decorative shield as set forth in claim 2, wherein:
said shield is mechanically cut, shaped and scored to stand unaccompanied.

4. A decorative shield as set forth in claim 3, wherein:
said shield is primarily rectangle in shape to surround uplight.

5. A decorative shield as set forth in claim 4, wherein:
said shield is light weight, heat resistant, compact and durable.

6. A decorative shield as set forth in claim 5, wherein:
said shield is also used as a safety barrier between the uplight and event patron.
